(19) United States
(12) Patent Application Publication
(10) Pub. No.: US 2017/0090318 A1
(43) Pub. Date: Mar. 30, 2017

(54) BRILLIANT TONER, ELECTROSTATIC CHARGE IMAGE DEVELOPER, AND TONER CARTRIDGE

(71) Applicant: FUJI XEROX CO., LTD., Tokyo (JP)

(72) Inventors: Atsushi SUGITATE, Kanagawa (JP); Masaru TAKAHASHI, Kanagawa (JP)

(73) Assignee: FUJI XEROX CO., LTD., Tokyo (JP)

(21) Appl. No.: 15/048,243

(22) Filed: Feb. 19, 2016

(30) Foreign Application Priority Data
Sep. 25, 2015 (JP) 2015-188615

(51) Int. Cl. G03G 9/00

(52) U.S. Cl. CPC G03G 9/08755; G03G 9/09; G03G 9/0821; G03G 9/0825

(57) ABSTRACT

A brilliant toner includes toner particles containing a brilliant pigment, an organic pigment, a binder resin and a release agent; and an external additive, wherein a toluene insoluble portion other than the brilliant pigment and the external additive is from 8% by weight to 40% by weight.

### CROSS-REFERENCE TO RELATED APPLICATIONS

This application is based on and claims priority under 35 USC 119 from Japanese Patent Application No. 2015-188615 filed Sep. 25, 2015.

### BACKGROUND

1. Technical Field

The present invention relates to a brilliant toner, an electrostatic charge image developer, and a toner cartridge.

2. Related Art

In recent years, for the purpose of forming an image having brilliance similar to metallic luster, the use of brilliant toners including a brilliant pigment has been examined.

### SUMMARY

A brilliant toner includes:

toner particles containing a brilliant pigment, an organic pigment, a binder resin and a release agent; and

an external additive,

wherein a toluene insoluble portion other than the brilliant pigment and the external additive is from 8% by weight to 40% by weight.

### BRIEF DESCRIPTION OF THE DRAWINGS

Exemplary embodiments of the present invention will be described in detail based on the following figures, wherein:

FIG. 1 is a cross-sectional view schematically showing an example of a toner particle according to an exemplary embodiment;

FIG. 2 is a schematic configuration diagram showing an example of an image forming apparatus according to an exemplary embodiment; and

FIG. 3 is a schematic configuration diagram showing an example of a process cartridge according to an exemplary embodiment.

### DETAILED DESCRIPTION

Hereinafter, exemplary embodiments of a brilliant toner, an electrostatic charge image developer, a toner cartridge, a process cartridge, an image forming apparatus, and an image forming method of the present invention will be described in detail.

Brilliant Toner

A brilliant toner according to an exemplary embodiment (hereinafter, sometimes referred to as “toner”) is a toner including a brilliant pigment, an organic pigment, a binder resin, a release agent, and an external additive, in which the amount of a portion insoluble in toluene (herein after referred to as “toluene insoluble portion”) other than the brilliant pigment and the external additive is from 8% by weight to 40% by weight.

According to the toner of the exemplary embodiment, a change in color tone of a toner image is prevented. The reason thereof is not clear but is presumed as follows.

In the related art, in a brilliant chromatic color toner including an organic pigment as an colored pigment and an aluminum pigment as a brilliant pigment, in the case in which the aluminum pigment is fixed so as to be aligned to paper to enhance brilliance, the thickness of the resin layer on the surface of the aluminum pigment is decreased in some cases. In addition, the amount of the colored pigment present on the surface of the aluminum pigment is reduced. As a result, the color tone (L*a*b*, a gloss change and the like) of the toner image formed using the brilliant chromatic color toner may be changed.

In the toner according to the exemplary embodiment containing a brilliant pigment, an organic pigment, a binder resin, a release agent, and an external additive, the amount of the toluene insoluble portion other than the brilliant pigment and the external additive is set to be in a range of 8% by weight to 40% by weight. The main component (for example, 75% by weight or more of the entirety) included in the toluene insoluble portion according to the exemplary embodiment is considered as a high molecular weight resin component included in the binder resin. By setting the amount of the toluene insoluble portion to a range of 8% by weight to 40% by weight, when a toner image is fixed on paper as a recording medium, excessive bleeding of the binder resin to the paper is prevented and a phenomenon that the thickness of the resin layer on the surface of the brilliant pigment is decreased and a phenomenon that the amount of the colored pigment present on the surface of the brilliant pigment is reduced are prevented. As a result, it is presumed that a change in color tone is prevented.

In the exemplary embodiment, the amount of the toluene insoluble portion other than the brilliant pigment and the external additive is in a range of 8% by weight to 40% by weight. When the amount of the toluene insoluble portion other than the brilliant pigment and the external additive is less than 8% by weight, the color tone of the fixed image may change. On the other hand, when the amount of the toluene insoluble portion other than the brilliant pigment and the external additive is more than 40% by weight, fixability may be poor and image brilliance may be decreased.

In the exemplary embodiment, the amount of the toluene insoluble portion other than the brilliant pigment and the external additive is preferably from 15% by weight to 35% by weight and more preferably from 20% by weight to 30% by weight.

In the exemplary embodiment, the amount of the toluene insoluble portion other than the brilliant pigment and the external additive may be adjusted to be in a range of 8% by weight to 40% by weight by, for example, 1) a method of forming a crosslinked structure by adding a crosslinking agent to a polymer component having a reactive functional group at the end or a branched structure, 2) a method of forming a crosslinked structure or a branched structure in a polymer component having an ionic functional group at the end by using polyvalent metal ions, and the like.

In the exemplary embodiment, the amount of the toluene insoluble portion other than the brilliant pigment and the external additive refers to a value measured by the following method.

First, toner particles in a toner to be measured are embedded using a bisphenol A type liquid epoxy resin and a curing agent and thus a sample for cutting is prepared. Next, the sample is cut into a sliced piece at −100° C. using a cutting machine with a diamond knife, for example, Ultracut UCT (manufactured by Leica Microsystems).

Using a scanning electron microscope with an energy dispersion type X-ray analyzer (SEM-EDX), the cross section of the sliced piece is observed and the constituent elements of the brilliant pigment (which is observed as a needle shape in the cross section) and the external additive present in the toner are identified using an energy dispersion type X-ray analyzer (EDX). Then, the amount of the brilliant pigment and the external additive (% by weight) is determined using a fluorescent X-ray analyzer.

Here, using “EMAX model 6923 H”, manufactured by HORIBA, Ltd., as the scanning electron microscope with an energy dispersion type X-ray analyzer, measurement is performed under the condition of an accelerating voltage of 20 kV. On the other hand, using “XRF-1500”, manufactured by Shimadzu Corporation, as the fluorescent X-ray analyzer, measurement is performed under the conditions of a tube voltage of 40 kV, a tube current of 90 mA, and a measurement time of 5 minutes.

On the other hand, 1 g of toner is weighed and the toner is placed into a weighed cylindrical filter paper made of glass fiber. The filter paper is mounted on an extraction tube of a heating type Soxhlet extractor. Then, toluene is poured into a flask, followed by heating to 110° C. with a mantle heater. In addition, the peripheral portion of the extraction tube is heated to 100° C. using the heating heater mounted on the extraction tube. Extraction is performed at a circulation speed at which the extraction cycle is one cycle in a range of 4 minutes to 5 minutes. After extraction for 10 hours, the cylindrical filter paper and toner residues are collected, dried, and weighed.

Thereafter, the amount of toner residues (% by weight) is calculated based on an equation: amount of toner residues (% by weight)=[(weight of cylindrical filter paper+amount of toner residues) (g)−weight of cylindrical filter paper (g)]/weight of toner (g)×100. The toner residues include the brilliant pigment, the external additive, the organic pigment, and the toluene insoluble portion of the binder resin. In addition, in the case in which the toner particles include a release agent, the release agent becomes a toluene insoluble portion on performing extraction under heating.

The amount of the toluene insoluble portion other than the brilliant pigment and the external additive (% by weight) is calculated from the “amount of the brilliant pigment and the external additive (% by weight)” determined by a fluorescent X-ray analyzer, and the “amount of toner residues (% by weight)” determined by extraction with a heating type Soxhlet extractor. That is, the amount of the toluene insoluble portion other than the brilliant pigment and the external additive (% by weight) is calculated from the equation “amount of toluene insoluble portion other than brilliant pigment and external additive (% by weight)”=“amount of toner residues (% by weight)”−“amount of brilliant pigment and external additive (% by weight)”.

Here, the “brilliance” in the toner according to the exemplary embodiment indicates that an image has brilliance similar to metallic luster when the image formed using the brilliant toner is visually checked.

Specifically, in the case in which a solid image is formed using the toner according to the exemplary embodiment, it is preferable that a ratio (X/Y) between a reflectance X at a light receiving angle of +30° measured when the image is irradiated with incident light at an incident angle of −45° by a goniophotometer and a reflectance Y at a light receiving angle of −30° is from 2 to 100.

If the ratio (X/Y) is equal to or greater than 2, this indicates that light is reflected more toward a side (“angle+” side) opposite to the light incident side than toward a side (“angle−” side) where the incident light enters, that is, this indicates that diffuse reflection of the incident light is prevented. When the diffuse reflection in which the incident light is reflected to various directions is caused, if the reflected light is visually checked, colors look blurry. Therefore, in the case in which the ratio (X/Y) is less than 2, if the reflected light is visually checked, brilliance is not confirmed, thereby causing inferior brilliant properties in some cases.

On the other hand, in the case in which the ratio (X/Y) exceeds 100, a viewing angle in which the reflected light may be visually checked is narrowed too much, and specular reflected light components become large. Therefore, a phenomenon in which colors look darkish depending on angles may occur. In addition, it is also difficult to prepare a toner in which the ratio (X/Y) exceeds 100.

The ratio (X/Y) is more preferably from 4 to 50, still more preferably from 6 to 20, and particularly preferably from 8 to 15.

Measurement of Ratio (X/Y) by Goniophotometer

Here, first, an incident angle and a light receiving angle will be described. In the exemplary embodiment, when the measurement is performed by a goniophotometer, an incident angle is set to −45°. This is because the measuring sensitivity to an image having a wide gloss level is high.

In addition, the reason why the light receiving angles are set to −30° and +30° is that the measuring sensitivity for determining an image with brilliance and an image without brilliance is highest.

Next, the measuring method of the ratio (X/Y) will be described.

An image to be measured (brilliance image) is irradiated with incident light at an incident angle of −45° with respect to the image using a spectro-goniophotometer GC 5000L manufactured by Nippon Denshoku Industries Co., Ltd. as a goniophotometer, and a reflectance X at a light receiving angle of +30° and a reflectance Y at a light receiving angle of −30° are measured. In addition, the reflectance X and the reflectance Y are respectively obtained by performing measurement with light in a wavelength range of 400 nm to 700 nm at intervals of 20 nm and calculating the average value of reflectances of the respective wavelengths. The ratio (X/Y) is calculated from the measurement results.

From the viewpoint of satisfying the ratio (X/Y) described above, the toner according to the exemplary embodiment preferably satisfies the requirements (1) and (2) below.

(1) The toner particle has an average equivalent circle diameter D larger than an average maximum thickness C.

(2) In the case in which the cross section of the toner particle in the thickness direction thereof is observed, the proportion of brilliant pigment particles arranged so that an angle formed by a long axis direction of the toner particle in the cross section and a long axis direction of the brilliant pigment particle is in a range of −30° to +30° is equal to or greater than 60% of the total number of brilliant pigment particles to be observed.

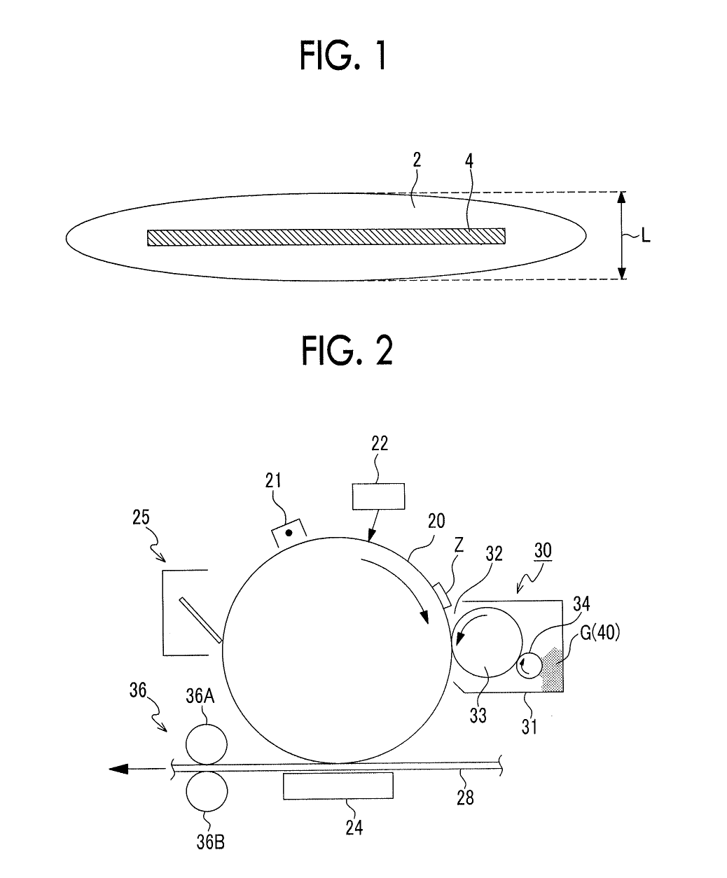

When the toner particles have a flake shape in which the equivalent circle diameter is larger than the thickness (refer to FIG. 1), it is considered that the flake-shaped toner particles are arranged such that the flake surface side of the toner faces a surface of a recording medium by the pressure at the time of fixing in a fixing step for image formation. In FIG. 1, the reference numeral 2 represents a toner particle, the reference numeral 4 represents a brilliant pigment, and the reference symbol L represents the thickness of the toner particle.

Accordingly, among the flake-shaped brilliant pigment particles contained in the toner particles, brilliant pigment particles that satisfy the requirement “an angle formed by a long axis direction of the toner particles in the cross section and a long axis direction of brilliant pigment particles is in a range of −30° to +30° ” described in (2) above are considered to be arranged such that the surface side, which provides the maximum area, faces the surface of the recording medium. In the case in which an image formed in this manner is irradiated with light, it is considered that the proportion of the brilliant pigment particles, which cause diffuse reflection of incident light, is reduced and thus the above-described range of the ratio (X/Y) may be achieved.

Hereinafter, the toner according to the exemplary embodiment will be described in detail.

The toner according to the exemplary embodiment includes a brilliant pigment, an organic pigment, a binder resin, a release agent, and an external additive. The toner according to the exemplary embodiment may include other component if necessary.

The toner according to the exemplary embodiment may contain toner particles including a brilliant pigment, an organic pigment, a binder resin, and a release agent, and an external additive to be externally added to the toner particles.

Toner Particles

The toner particles may include a brilliant pigment, an organic pigment, a binder resin, and a release agent. The toner particles may include other additives, if necessary.

Binder Resin

Examples of the binder resin include a homopolymer formed from monomers such as styrenes (for example, styrene, para-chlorostyrene, a-methyl styrene, or the like), (meth)acrylic esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, or the like), ethylenic unsaturated nitriles (for example, acrylonitrile, methacrylonitrile, or the like), vinyl ethers (for example, vinyl methyl ether, vinyl isobutyl ether, or the like), vinyl ketones (for example, vinyl methyl ketone, vinyl ethyl ketone, vinyl isopropenyl ketone, or the like), olefins (for example, ethylene, propylene, butadiene, or the like), or a vinyl resin being a copolymer obtained by combining two or more kinds of these monomers.

Examples of the binder resin also include a non-vinyl resin such as an epoxy resin, a polyester resin, a polyurethane resin, a polyamide resin, a cellulose resin, a polyether resin, and a modified rosin, a mixture of these and the above described vinyl resin, or a graft polymer obtained by polymerizing a vinyl monomer in the presence thereof.

These binder resins may be used alone or in combination with two or more kinds thereof.

As the binder resin, a polyester resin is suitable. As the polyester resin, a well-known polyester resin is used, for example.

Examples of the polyester resin include polycondensates of polyvalent carboxylic acids and polyols. A commercially available product or a synthesized product may be used as the polyester resin.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, or lower alkyl esters (having, for example, from 1 to 5 carbon atoms) thereof. Among these, for example, aromatic dicarboxylic acids are preferably used as the polyvalent carboxylic acid.

As the polyvalent carboxylic acid, a tri- or higher-valent carboxylic acid employing a crosslinked structure or a branched structure may be used in combination together with a dicarboxylic acid. Examples of the tri- or higher-valent carboxylic acid include trimellitic acid, pyromellitic acid, anhydrides thereof, or lower alkyl esters (having, for example, from 1 to 5 carbon atoms) thereof.

The polyvalent carboxylic acids may be used alone or in combination of two or more kinds thereof.

Examples of the polyol include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic dials (for example, ethylene oxide adduct of bisphenol Aand propylene oxide adduct of bisphenol A). Among these, for example, aromatic diols and alicyclic diols are preferably used, and aromatic diols are more preferably used as the polyol.

As the polyol, a tri- or higher-valent polyol employing a crosslinked structure or a branched structure may be used in combination together with a diol. Examples of the tri- or higher-valent polyol include glycerin, trimethylolpropane, and pentaerythritol.

The polyols may be used alone or in combination of two or more kinds thereof.

The glass transition temperature (Tg) of the binder resin such as the polyester resin is preferably from 50° C. to 80° C., and more preferably from 50° C. to 65° C.

The glass transition temperature is determined by a DSC curve obtained by differential scanning calorimetry (DSC), and more specifically, is determined by “Extrapolated Starting Temperature of Glass Transition” disclosed in a method of determining a glass transition temperature of JIS K 7121-1987 “Testing Methods for Transition Temperature of Plastics”.

The weight average molecular weight (Mw) of the polyester resin is preferably from 5,000 to 1,000,000 and more preferably from 7,000 to 500,000.

The number average molecular weight (Mn) of the polyester resin is preferably from 2,000 to 100,000.

The molecular weight distribution Mw/Mn of the polyester resin is preferably from 1.5 to 100 and more preferably from 2 to 60.

The weight average molecular weight and the number average molecular weight are measured by gel permeation chromatography (GPC). The molecular weight measurement by GPC is performed by using GPC.HLC-8120, GPC manufactured by Tosoh Corporation as a measuring device, TSKgel SuperHM-M (15 cm) manufactured by Tosoh Corporation, as a column, and a THF solvent. The weight average molecular weight and the number average molecular weight are calculated using a calibration curve of molecular weight obtained with a monodisperse polystyrene standard sample from the measurement results obtained from the measurement.

A known preparing method is applied to prepare the polyester resin. Specific examples thereof include a method of conducting a reaction at a polymerization temperature set to 180° C. to 230° C., if necessary, under reduced pressure in the reaction system, while removing water or an alcohol generated during condensation.

In the case in which monomers of the raw materials are not dissolved or compatibilized under a reaction temperature, a high-boiling-point solvent may be added as a solubilizing agent to dissolve the monomers. In this case, a polycondensation reaction is conducted while distilling away the solubilizing agent. In the case in which a monomer having poor compatibility is present in a copolymerization reaction, the monomer having poor compatibility and an acid or an alcohol to be polycondensed with the monomer may be previously condensed and then polycondensed with the main component.

Here, examples of the polyester resin also include modified polyester resins other than the aforementioned unmodified polyester resins. The modified polyester resin include a polyester resin in which bonding groups other than an ester bond are present, and a polyester resin in which resin components different from a polyester resin component are bonded by a covalent bond, an ionic bond and the like. Examples of the modified polyester resin include resins in which the end is modified by reaction of a polyester resin into which a functional group such as an isocyanate group reacting with an acid group or a hydroxyl group at the end thereof is introduced, with an active hydrogen compound.

As the modified polyester resin, a urea-modified polyester resin is particularly preferable. When the toner particles include a urea-modified polyester resin as the binder resin, a change in color tone of a toner image is easily prevented. It is considered that this is because the urea-modified polyester resin becomes a toluene insoluble portion and has an appropriate hydrophilicity, the resin is arranged in the toner so as to surround the edge portion of the brilliant pigment. From this viewpoint, the content of the urea-modified polyester resin is preferably from 10% by weight to 30% by weight and more preferably from 15% by weight to 25% by weight with respect to the total binder resin.

The urea-modified polyester resin may be a urea-modified polyester resin that is obtained from a reaction (at least one of crosslinking reaction and elongation reaction) between a polyester resin having isocyanate groups (polyester prepolymer) and an amine compound. The urea-modified polyester resin may contain a urea bond together with a urethane bond.

As the polyester prepolymer having isocyanate groups, a prepolymer obtained by reacting a polyester which is a polycondensate of a polyvalent carboxylic acid and a polyol and has active hydrogen with a polyisocyanate compound may be used. Examples of an active hydrogen containing group of the polyester include hydroxyl groups (alcoholic hydroxyl group and phenolic hydroxyl group), an amino group, a carboxyl group, and a mercapto group. The alcoholic hydroxyl group is preferable.

In the polyester prepolymer having isocyanate groups, the polyvalent carboxylic acid and the polyol are compounds similar to the above examples of the polyvalent carboxylic acid and the polyol mentioned in the description of the polyester resin.

Examples of the polyvalent isocyanate compound include aliphatic polyisocyanates (such as tetramethylene diisocyanate, hexamethylene diisocyanate, and 2,6-diisocyanate methylcaproate); alicyclic polyisocyanates (such as isophorone diisocyanate and cyclohexylmethane diisocyanate); aromatic diisocyanates (such as tolylene diisocyanate and diphenylmethane diisocyanate); aromatic aliphatic diisocyanates (such as α,α,α′,α′-tetramethylxylylene diisocyanate); isocyanurates; and compounds formed by blocking the above polyisocyanates with a blocking agent such as a phenol derivative, oxime, caprolactam, or the like.

These polyisocyanates maybe used alone or in combination of two or more kinds thereof.

The ratio of the polyvalent isocyanate compound is, in terms of an equivalent ratio [NCO]/[OH] between the isocyanate group [NCO] and the hydroxyl group [OH] of the hydroxyl containing polyester prepolymer, preferably from 1/1 to 5/1, more preferably from 1.2/1 to 4/1, and still more preferably from 1.5/1 to 2.5/1. When the ratio [NCO]/[OH] is from 1/1 to 5/1, the amount of the toluene insoluble portion is likely to be in the above range, and a change in color tone of a toner image is easily prevented. When the ratio [NCO]/[OH] is 5 or less, deterioration of low temperature fixability is easily prevented.

The content of a component derived from the polyvalent isocyanate compound in the polyester prepolymer having isocyanate groups is preferably from 0.5% by weight to 40% by weight, more preferably from 1% by weight to 30% by weight, and still more preferably from 2% by weight to 20% by weight with respect to the polyester prepolymer having isocyanate groups. When the content of the component derived from the polyvalent isocyanate compound is from 0.5% by weight to 40% by weight, the amount of the toluene insoluble portion is likely to be in the above range and a change in color tone of a toner image is easily prevented. When the content of the component derived from the polyvalent isocyanate compound is 40% by weight or less, deterioration of low temperature fixability is easily prevented.

The average number of isocyanate groups contained per molecule of the polyester prepolymer having isocyanate groups is preferably from 1 or more, more preferably from 1.5 to 3, and still more preferably from 1.8 to 2.5. When the number of isocyanate groups per molecule is 1 or more, the molecular weight of the urea-modified polyester resin after completion of reaction increases, the amount of the toluene insoluble portion is likely to be in the above range, and a change in color tone of a toner image is easily prevented.

Examples of the amine compound reacting with the polyester prepolymer having isocyanate groups include diamines, tri- or higher-valent polyamines, amino alcohols, amino mercaptans, amino acids, and compounds obtained by blocking these amino groups.

Examples of the diamines include aromatic diamines (such as phenylenediamine, diethyltoluenediamine, and 4,4′-diaminodiphenylmethane), alicyclic diamines (such as 4,4′-diamino-3,3′-dimethyldicyclohexylmethane, diaminecyclohexane, and isophoronediamine); and aliphatic diamines (such as ethylenediamine, tetramethylenediamine, and hexamethylenediamine).

Examples of the tri- or higher-valent polyamines include diethylenetriamine and triethylenetetramine.

Examples of amino alcohols include ethanolamine and hydroxyethyl aniline.

Examples of the amino mercaptans include aminoethyl mercaptan and aminopropyl mercaptan.

Examples of the amino acids include aminopropionic acid and aminocaproic acid.

Examples of the compounds obtained by blocking these amino groups include ketimine compounds obtained from amine compounds, such as diamines, tri- or higher-valent polyamines, amino alcohols, amino mercaptans, and amino acids, and ketone compounds (such as acetone, methyl ethyl ketone, and methyl isobutyl ketone) and oxazoline compounds.

Among these amine compounds, ketimine compounds are preferable.

These amine compounds may be used alone or in combination of two or more kinds thereof. The molecular weight of the urea-modified polyester resin after completion of the reaction may be adjusted by adjusting reaction between the polyester resin having isocyanate groups (polyester prepolymer) and the amine compound (at least one of a crosslinking reaction and an elongation reaction) with a reaction terminator which terminates at least one of a crosslinking reaction and an elongation reaction (hereinafter, also referred to as “crosslinking/elongation reaction terminator”).

Examples of the crosslinking/elongation reaction terminator include monoamines (such as diethylamine, dibutylamine, butylamine, and laurylamine) and blocked compounds thereof (ketimine compounds).

The ratio of the amine compound is, in terms of an equivalent ratio [NCO]/[NHx] between the isocyanate group [NCO] in the polyester prepolymer having isocyanate groups and the amino group [NHx] in the amines, preferably from 1/2 to 2/1, more preferably from 1/1.5 to 1.5/1, and still more preferably from 1/1.2 to 1.2/1. When the [NCO]/[NHx] is in the above range, the molecular weight of the urea-modified polyester resin after completion of reaction increases, the amount of the toluene insoluble portion is likely to be in the above range, and a change in color tone of a toner image is easily prevented.

The glass transition temperature of the urea-modified polyester resin is preferably from 40° C. to 65° C. and more preferably from 45° C. to 60° C. The number average molecular weight thereof is preferably from 2,500 to 50,000 and more preferably from 2,500 to 30,000. The weight average molecular weight is preferably from 10, 000 to 500, 000 and more preferably from 30,000 to 100,000.

For example, the content of the binder resin is from 40% by weight to 95% by weight, more preferably from 50% by weight to 90% by weigh, and still more preferably from 60% by weight to 85% by weight with respect to the total toner particles.

Brilliant Pigment

As the brilliant pigment, for example, a pigment (brilliant pigment) that may provide brilliance similar to metallic luster may be used. Specific examples of the brilliant pigment include metal powders such as aluminum (Al element metal), brass, bronze, nickel, stainless steel, and zinc powders; coated flaky inorganic crystalline substances, such as mica, barium sulfate, layered silicate and layered aluminum silicate coated with titanium oxide or yellow iron oxide; single-crystal planar titanium oxide; basic carbonates; acid bismuth oxychloride; natural guanine; foil-shaped glass powder; and metal-deposited foil-shaped glass powder. The brilliant pigment is not particularly limited as long as the pigment has brilliance.

Among the brilliant pigments, particularly, from the viewpoint of mirror surface reflection intensity, metal powders are preferable, and among these metal powders, aluminum is most preferable.

The brilliant pigment preferably has a flake shape.

The average length of the brilliant pigment in a long axis direction is preferably from 1 μm to 30 μm, more preferably from 3 μm to 20 μm, and still more preferably from 5 μm to 15 μm.

The ratio (aspect ratio) of the average length in the long axis direction when the average length of the brilliant pigment in a thickness direction is taken as 1, is preferably from 5 to 200, more preferably from 10 to 100, and still more preferably 30 to 70.

The respective average lengths and the aspect ratio of the brilliant pigment are measured by the following method. A photograph of the pigment particles is captured by using a scanning electron microscope (S-4800, manufactured by Hitachi High Technologies Co., Ltd.), with measurable magnification power (from 300 times to 100,000 times), the length of each particle in the long axis direction and the length thereof in a thickness direction are measured in a two-dimensional state of the obtained image of the pigment particle, and the average length in the long axis direction and the aspect ratio of the brilliant pigment are calculated.

The content of the brilliant pigment is, for example, preferably from 1 part by weight to 50 parts by weight and more preferably from 15 parts by weight to 25 parts by weight, with respect to 100 parts by weight of the toner particles.

Organic Pigment

Examples of the organic pigment include various pigment such as carbon black, Chrome Yellow, Hansa Yellow, Benzidine Yellow, Threne Yellow, Quinoline Yellow, Pigment Yellow, Permanent orange GTR, Pyrazolone Orange, Vulcan Orange, Watchung Red, Permanent Red, Brilliant Carmine 3B, Brilliant Carmine 6B, Du-pont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate.

The organic pigments may be used alone or in combination of two or more kinds thereof.

The organic pigment may be an organic pigment whose surface is treated if necessary, or may be used together with a dispersion. In addition, plural kinds of organic pigments may be used in combination.

For example, the content of the organic pigment is preferably from 1% by weight to 30% by weight and more preferably from 3% by weight to 15% by weight with respect to the total toner particles.

Release Agent

Examples of the release agent include hydrocarbon waxes; natural waxes such as carnauba wax, rice wax, and candelilla wax; synthetic or mineral/petroleum waxes such as montan wax; and ester waxes such as fatty acid esters and montanic acid esters. The release agent is not limited thereto.

The melting temperature of the release agent is preferably from 50° C. to 110° C. and more preferably from 60° C. to 100° C.

The melting temperature is obtained from “melting peak temperature” described in the method of obtaining a melting temperature in JIS K 1721-1987 “Testing methods for transition temperatures of plastics”, from a DSC curve obtained by differential scanning calorimetry (DSC).

The content of the release agent is, for example, preferably from 1% by weight to 20% by weight, and more preferably from 5% by weight to 15% by weight with respect to the total toner particles.

Other Additives

Examples of other additives include known additives such as a magnetic material, a charge-controlling agent, and an inorganic particle. The toner particles include these additives as internal additives.

Examples of the charge-controlling agent include quaternary ammonium salt compounds, nigrosine compounds, dyes containing a complex of aluminum, iron, chromium, or the like, and triphenylmethane pigments.

Examples of the inorganic particles include known inorganic particles such as silica particles, titanium oxide particles, alumina particles, cerium oxide particles, and particles obtained by hydrophobizing the surfaces of these particles. These inorganic particles may be used alone or in combinations of two or more kinds thereof. Among these inorganic particles, silica particles, which have a refractive index lower than that of the above-described binder resin, are preferably used. The silica particles may be subjected to various surface treatments. For example, silica particles surface-treated with a silane coupling agent, a titanium coupling agent, silicone oil, or the like are preferably used.

Characteristics of Toner Particles

The toner particles may be toner particles having a single layer structure, or toner particles having a so-called core/shell structure composed of a core (core particle) and a coating layer (shell layer) coated on the core.

The toner particles having a core/shell structure may be composed of, for example, a core containing a brilliant pigment, an organic pigment, a binder resin, a release agent, and if necessary, other additives, and a coating layer containing a binder resin.

Average Maximum Thickness C and Average Equivalent Circle Diameter D of Toner Particles

The toner particles have a flake shape and the average equivalent circle diameter D is preferably longer than the average maximum thickness C. In addition, the ratio (C/D) of the average maximum thickness C to the average equivalent circle diameter D is more preferably in a range of 0.001 to 0.700, still more preferably in a range of 0.100 to 0.600, and particularly preferably in a range of 0.300 to 0.450.

When the ratio (C/D) is 0.001 or more, toner strength is increased and fracturing that is caused by a stress in the image formation is prevented, and thus a reduction in charges that is caused by exposure of the pigment, and fogging that is caused as a result thereof are prevented. On the other hand, when the ratio (C/D) is 0.700 or less, excellent brilliance is obtained.

The average maximum thickness C and the average equivalent circle diameter D are measured by the method below.

Toner particles are placed on a smooth surface and uniformly dispersed by applying vibrations. One thousand toner particles are observed with a color laser microscope “VK-9700” (manufactured by Keyence Corporation) at a magnification of 1,000 times to measure the maximum thickness C and the equivalent circle diameter D of a surface viewed from the top in the brilliant toner particles, and the arithmetic averages thereof are calculated to determine the average maximum thickness C and the average equivalent circle diameter D.

Angle Formed by Long Axis Direction of Toner Particles in Cross Section and Long Axis Direction of Brilliant Pigment Particles

In the case in which the cross section of toner particles in the thickness direction thereof is observed, the number (number reference) of pigment particles arranged so that an angle formed by a long axis direction of the toner particles in the cross section and a long axis direction of brilliant pigment particles is in the range of −30° to +30° is preferably 60% or more of the total number of brilliant pigment particles to be observed. Furthermore, the number is more preferably from 70% to 95%, and particularly preferably from 80% to 90%.

When the above number is 60% or more, a good brilliance may be obtained.

Here, a method of observing the cross section of the toner particles will be described.

Toner particles are embedded in a mixture of a bisphenol A-type liquid epoxy resin and a curing agent to prepare a sample for cutting. Next, the sample for cutting is cut at −100° C. using a cutting machine with a diamond knife, (for example, using an ultramicrotome (Ultracut UCT, manufactured by Leica Microsystems)) to prepare a sample for observation. The sample for observation is observed using an ultrahigh resolution field emission scanning electron microscope (S-4800, manufactured by Hitachi High Technologies Co., Ltd.) with magnification power with which about 1 to 10 toner particles are observed in one view field.

Specifically, the cross section of the toner particles (the cross section of the toner particles in the thickness direction) is observed and regarding the observed 100 toner particles, the number of brilliant pigment particles arranged so that an angle formed by the long axis direction of the toner particles in the cross section and the long axis direction of the brilliant pigment particles is in a range of −30° to +30° is counted by using, for example, image analysis software (WinROOF) manufactured by Mitani Corporation or using an output sample of the observed image and a protractor and the ratio thereof is calculated.

The term “long axis direction of toner particle in the cross section” refers to a direction orthogonal to a thickness direction of toner particle having an average equivalent-circle diameter D larger than the average maximum thickness C, and the term “long axis direction of a brilliant pigment particle” refers to a length direction of the brilliant pigment particle.

The volume average particle diameter of the toner particles is preferably from 1 μm to 30 μm and more preferably from 3 μm to 20 μm.

The volume average particle diameter D₅₀ᵥ of the toner particles is determined as follows. A cumulative volume distribution curve and a cumulative number distribution curve are drawn from the smaller particle diameter end, respectively, for each particle diameter range (channel) divided on the basis of a particle diameter distribution measured with a measuring instrument such as a Multisizer II (manufactured by Beckman Coulter Inc.). The particle diameter providing 16% accumulation is defined as that corresponding to volume D₁₆ᵥ and number D₁₆ₚ, the particle diameter providing 50% accumulation is defined as that corresponding to volume D₅₀ᵥ and number D₅₀ₚ, and the particle diameter providing 84% accumulation is defined as that corresponding to volume D₈₄ᵥ and number D₈₄ₚ. The volume average particle diameter distribution index (GSDv) is calculated as (D₈₄ᵥ/D₁₆ᵥ)^{1/2} using these values.

External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

The surfaces of the inorganic particles used as the external additive may be treated with a hydrophobizing agent. The hydrophobizing treatment is performed by, for example, dipping the inorganic particles in a hydrophobizing agent. The hydrophobizing agent is not particularly limited and examples thereof include a silane coupling agent, silicone oil, a titanate coupling agent, and an aluminum coupling agent. These may be used alone or in combination of two or more kinds thereof.

Generally, the amount of the hydrophobizing agent is, for example, from 1 part by weight to 10 parts by weight with respect to 100 parts by weight of the inorganic particles.

Examples of the external additive also include resin particles (resin particles such as polystyrene, polymethyl methacrylate (PMMA), and melamine resin) and a cleaning aid (for example, a metal salt of higher fatty acid represented by zinc stearate, and fluorine polymer particles).

The amount of the external additive externally added is, for example, preferably from 0.01% by weight to 5% by weight and more preferably from 0.01% by weight to 2.0% by weight, with respect to the toner particles.

Toner Preparing Method Next, a method of preparing the toner according to the exemplary embodiment will be described.

The toner according to the exemplary embodiment is obtained by externally adding an external additive to toner particles after preparing the toner particles including the brilliant pigment.

The toner particles may be prepared by a dry method (for example, a kneading and pulverizing method), or a wet method (for example, an aggregation and coalescence method, a suspension and polymerization method, and a dissolution and suspension method). The toner particle preparing method is not particularly limited to these methods, and a known method is employed.

For example, the dissolution and suspension method is a method of obtaining toner particles by granulation including: dispersing a liquid, formed by dissolving or dispersing raw materials constituting toner particles (such as resin particles and a brilliant pigment) in an organic solvent in which a binder resin is soluble, in an aqueous solvent containing a particle dispersant, and then removing the organic solvent.

In addition, an aggregation and coalescence method is a method of obtaining toner particles including: an aggregation step of forming aggregates of raw materials constituting toner particles (such as resin particles and a brilliant pigment), and a coalescence step of coalescing the aggregates.

Among these, toner particles including a urea-modified polyester resin as the binder resin may be obtained by the following dissolution and suspension method. In the description of the dissolution and suspension method described below, a method of obtaining toner particles including an unmodified polyester resin and a urea-modified polyester resin as a binder resin will be described. However, the toner particles may include only a urea-modified polyester resin as a binder resin.

Oil Phase Liquid Preparation Step

An oil phase liquid obtained by dissolving or dispersing toner particle materials including a unmodified polyester resin, a polyester prepolymer having isocyanate groups, an amine compound, a brilliant pigment, an organic pigment, and a release agent in an organic solvent is prepared (oil phase liquid preparation step). The oil phase liquid preparation step is a step of obtaining a mixed solution of toner materials by dissolving or dispersing the toner particle materials in the organic solvent.

The oil phase liquid may be prepared by methods such as 1) a preparation method of collectively dissolving or dispersing toner materials in an organic solvent, 2) a preparation method of kneading toner materials in advance, and then dissolving or dispersing the kneaded material in an organic solvent, 3) a preparation method of dissolving a unmodified polyester resin, a polyester prepolymer having isocyanate groups, and an amine compound in an organic solvent, and then dispersing a brilliant pigment, an organic pigment, and a release agent in the organic solvent, 4) a preparation method of dispersing a brilliant pigment, an organic pigment and a release agent in an organic solvent, and then dissolving a unmodified polyester resin, a polyester prepolymer having isocyanate groups, and an amine compound in the organic solvent, 5) a preparation method of dissolving or dispersing toner particle materials (an unmodified polyester resin, a brilliant pigment, an organic pigment, and a release agent), other than a polyester prepolymer having isocyanate groups and an amine compound, in an organic solvent, and then dissolving the polyester prepolymer having isocyanate groups and the amine compound in the organic solvent, and 6) a preparation method of dissolving or dispersing toner particle materials (an unmodified polyester resin, a brilliant pigment, an organic pigment, and a release agent), other than a polyester prepolymer having isocyanate groups and an amine compound, in an organic solvent, and then dissolving the polyester prepolymer having isocyanate groups or the amine compound in the organic solvent. The method of preparing the oil phase liquid is not limited thereto.

Examples of the organic solvent of the oil phase liquid include ester solvents such as methyl acetate and ethyl acetate; ketone solvents such as methyl ethyl ketone and methyl isopropyl ketone; aliphatic hydrocarbon solvents such as hexane and cyclohexane, and halogenated hydrocarbon solvents such as dichloromethane, chloroform, and trichloroethylene. These organic solvents are used for dissolving therein the binder resin, the water solubility thereof is preferably about from 0% by weight to 30% by weight, and the boiling temperature is preferably 100° C. or less. Among these organic solvents, ethyl acetate is preferable.

Suspension Preparation Step

Next, the obtained oil phase liquid is dispersed in a water phase liquid to prepare a suspension (suspension preparation step).

Reaction between the polyester prepolymer having isocyanate groups and the amine compound is conducted with preparation of the suspension. Then, a urea-modified polyester resin is formed by the reaction. This reaction accompanies at least one of crosslinking reaction and elongation reaction in a molecular chain. The reaction between the polyester prepolymer having isocyanate groups and the amine compound may be conducted with a solvent removal step, which will be described later.

Here, the reaction conditions are selected according to reactivity between the isocyanate group structure of the polyester prepolymer and the amine compound. For example, the reaction time is preferably from 10 minutes to 40 hours and more preferably from 2 hours to 24 hours. The reaction temperature is preferably from 0° C. to 150° C. and more preferably from 40° C. to 98° C. For the formation of the urea-modified polyester resin, if necessary, known catalyst (such as dibutyltin laurate and dioctyltin laurate) may be used. That is, a catalyst may be added to the oil phase liquid or the suspension.

Examples of the water phase liquid include water phase liquids in which a particle dispersant such as an organic particle dispersant or an inorganic particle dispersant is dispersed in an aqueous solvent. Examples of the water phase liquid also include water phase liquids in which a particle dispersant is dispersed in an aqueous solvent and a polymer dispersant is dissolved in the aqueous solvent. Known additives such as a surfactant may be added to the water phase liquid.

The aqueous solvent maybe water (for example, generally, ion exchange water, distilled water, and pure water). The aqueous solvent may be a solvent including an organic solvent such as alcohols (such as methanol, isopropyl alcohol, and ethylene glycol), dimethylformamide, tetrahydrofuran, cellosolves (such as methyl cellosolve), or lower ketones (such as acetone, and methyl ethyl ketone), together with water.

Examples of the organic particle dispersant include hydrophilic organic particle dispersants. Examples of the organic particle dispersant include particles of alkyl poly(meth)acrylate resin (for example, polymethyl methacrylate resin), and polystyrene resin, poly(styrene-acrylonitrile) resin. Examples of the organic particle dispersant also include particles of styrene acrylic resin.

Examples of the inorganic particle dispersant include hydrophilic inorganic particle dispersants. Specific examples of the inorganic particle dispersant include particles of silica, alumina, titania, calcium carbonate, magnesium carbonate, tricalcium phosphate, clay, diatomaceous earth, and bentonite and particles of calcium carbonate are preferable. The inorganic particle dispersants may be used alone or in combination of two or more kinds thereof.

The particle dispersant may be surface-treated with a polymer having a carboxyl group.

Examples of the polymer having a carboxyl group include copolymers between an α,β-monoethylenically unsaturated carboxylic ester and an α,β-monoethylenically unsaturated carboxylic acid or at least one selected from salts (such as alkali metal salts, alkaline earth metal salts, ammonium salts, and amine salts) obtained by neutralizing the carboxyl group of an α,β-monoethylenically unsaturated carboxylic acid with an alkali metal, an alkaline earth metal, ammonium or amine. Examples of the polymer having a carboxyl group also include salts (such as alkali metal salts, alkaline earth metal salts, ammonium salts and amine salts) obtained by neutralizing the carboxyl group of a copolymer between an α,β-monoethylenically unsaturated carboxylic acid and an α,β-monoethylenically unsaturated carboxylic ester with an alkali metal, an alkaline earth metal, ammonium or amine. The polymers having a carboxyl group may be used alone or in combination of two or more kinds thereof.

Representative examples of the α,β-monoethylenically unsaturated carboxylic acid include α,β-unsaturated monocarboxylic acids (such as acrylic acid, methacrylic acid, and crotonic acid), and α,β-unsaturated dicarboxylic acids (such as maleic acid, fumaric acid, and itaconic acid). In addition, representative examples of the α,β-monoethylenically unsaturated carboxylic ester include alkyl esters of (meth)acrylic acid, (meth) acrylates having an alkoxy group, (meth)acrylates having a cyclohexyl group, (meth)acrylates having a hydroxy group, and polyalkylene glycol mono(meth)acrylates.

Examples of the polymer dispersant include hydrophilic polymer dispersants. Specific examples of the polymer dispersant include polymer dispersants having a carboxyl group and not having a lipophilic group (such as a hydroxypropoxy group or a methoxy group) (for example, water-soluble cellulose ethers such as carboxymethyl cellulose, and carboxyethyl cellulose).

Solvent Removal Step

Next, a toner particle dispersion is obtained by removing the organic solvent from the obtained suspension (solvent removal step). In the solvent removal step, a toner particle is obtained by removing the organic solvent included in the droplets of the water phase liquid dispersed in the suspension. The organic solvent removal from the suspension may be performed immediately after the suspension preparation step, but may be performed when at least one minute has passed after the completion of the suspension preparation step.

In the solvent removal step, the organic solvent may be removed from the suspension by cooling or heating the obtained suspension to, for example, a range of 0° C. to 100° C.

As a specific method of removing the organic solvent, the following methods may be used.

(1) A method in which air is blown into the suspension to forcibly renew the gas phase on the surface of the suspension. In this case, a gas may be blown into the suspension.

(2) A method in which the pressure is reduced. In this case, the gas phase on the surface of the suspension may be forcibly renewed by purging with a gas or moreover, a gas may be blown into the suspension.

Toner particles are obtained through the above-described steps.

Here, after the completion of the solvent removal step, toner particles formed in the toner particle dispersion are subjected to known steps including a washing step, a solid-liquid separation step, and a drying step and thus dry toner particles are obtained.

The washing step may be performed by sufficient substitution and washing with ion exchange water from the viewpoint of charging properties.

In addition, the solid-liquid separation step is not particularly limited and suction filtration, pressure filtration, and the like maybe used from the viewpoint of productivity. In addition, the drying step is not particularly limited and from the viewpoint of productivity, freeze-drying, flush-jet drying, fluidized drying, or vibrating fluidized drying may be used.

Then, the toner according to the exemplary embodiment may be prepared by adding an external additive to the obtained dry toner particles and mixing the materials.

The mixing may be performed by using a V blender, a Henschel mixer, a ready-gel mixer, and the like.

Further, if necessary, coarse toner particles may be removed by using a vibration classifier, a wind classifier, and the like.

Electrostatic Charge Image Developer

An electrostatic charge image developer according to the exemplary embodiment at least includes the toner according to the exemplary embodiment.

The electrostatic charge image developer according to the exemplary embodiment may be a single component developer including only the toner according to the exemplary embodiment or maybe a two-component developer obtained by mixing the toner and a carrier.

The carrier is not particularly limited and known carriers may be used. Examples of the carrier include resin coated carriers in which the surface of the core formed of magnetic particles is coated with a resin; magnetic particle dispersion type carriers in which magnetic particles are dispersed and blended in a matrix resin; and resin impregnation type carriers in which porous magnetic particles are impregnated with a resin.

The magnetic particle dispersion type carriers and the resin impregnation type carriers may be carriers in which the constituent particles of the carrier are cores and the surface is coated with a resin.

Examples of the magnetic particles include magnetic metals such as iron, nickel, and cobalt, and magnetic oxides such as ferrite and magnetite.

Examples of the coating resin and the matrix resin include, polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylic acid copolymers, straight silicone resin including organosiloxane bonds and its modified products, fluorine resin, polyester, polycarbonate, phenolic resin, and epoxy resin. The coating resin and the matrix resin may include an additive such as conductive particles.

Examples of the conductive particles include metals such as gold, silver, and copper, and particles of carbon black, titanium oxide, zinc oxide, tin oxide, barium sulfate, aluminum borate, and potassium titanate.

The surface of the core may be coated with the resin by a method of using a coating layer forming solution obtained by dissolving a coating resin and various additives (used if necessary) in an appropriate solvent. The solvent is not particularly limited and may be selected in consideration of the kind of the coating resin to be used, the coating suitability and the like. Specific examples of the resin coating method include a dipping method of dipping cores in a coating layer forming solution, a spraying method of spraying a coating layer forming solution onto surfaces of cores, a fluidized bed method of spraying a coating layer forming solution onto cores in a state in which the cores are allowed to float by flowing air, and a kneader-coater method in which cores of a carrier and a coating layer forming solution are mixed with each other in a kneader-coater and then the solvent is removed.

The mixing ratio (weight ratio) between the toner and the carrier in the two-component developer is preferably from toner:carrier=1:100 to 30:100, and more preferably from 3:100 to 20:100.

Image Forming Apparatus and Image Forming Method

An image forming apparatus and an image forming method according to this exemplary embodiment will be described.

The image forming apparatus according to this exemplary embodiment is provided with an image holding member, a charging unit that charges a surface of the image holding member, an electrostatic charge image forming unit that forms an electrostatic charge image on the charged surface of the image holding member, a developing unit that accommodates an electrostatic charge image developer and develops the electrostatic charge image formed on the surface of the image holding member with the electrostatic charge image developer as a toner image, a transfer unit that transfers the toner image formed onto the surface of the image holding member to a surface of a recording medium, and a fixing unit that fixes the toner image transferred onto the surface of the recording medium. As the electrostatic charge image developer, the electrostatic charge image developer according to this exemplary embodiment is applied.

In the image forming apparatus according to this exemplary embodiment, an image forming method (image forming method according to this exemplary embodiment) including the steps of: charging a surface of an image holding member; forming an electrostatic charge image on the charged surface of the image holding member; developing the electrostatic charge image formed on the surface of the image holding member with the electrostatic charge image developer according to this exemplary embodiment as a toner image; transferring the toner image formed onto the surface of the image holding member to a surface of a recording medium; and fixing the toner image transferred onto the surface of the recording medium is performed.

As the image forming apparatus according to this exemplary embodiment, a known image forming apparatus is applied, such as a direct transfer type apparatus that directly transfers a toner image formed on a surface of an image holding member onto a recording medium; an intermediate transfer type apparatus that primarily transfers a toner image formed on a surface of an image holding member onto a surface of an intermediate transfer member, and secondarily transfers the toner image transferred to the surface of the intermediate transfer member onto a surface of a recording medium; an apparatus that is provided with a cleaning unit that cleans a surface of an image holding member before charging after transfer of a toner image; or an apparatus that is provided with an erasing unit that irradiates, after transfer of a toner image, a surface of an image holding member with erase light before charging for erasing.

In the case of an intermediate transfer type apparatus, a transfer unit is configured to have, for example, an intermediate transfer member having a surface to which a toner image is to be transferred, a primary transfer unit that primarily transfers a toner image formed on a surface of an image holding member onto the surface of the intermediate transfer member, and a secondary transfer unit that secondarily transfers the toner image transferred onto the surface of the intermediate transfer member onto a surface of a recording medium.

In the image forming apparatus according to this exemplary embodiment, for example, a part including the developing unit may have a cartridge structure (process cartridge) that is detachable from the image forming apparatus. As the process cartridge, for example, a process cartridge that accommodates the electrostatic charge image developer according to this exemplary embodiment and is provided with a developing unit is suitably used.

Hereinafter, an example of the image forming apparatus according to this exemplary embodiment will be shown. However, the image forming apparatus is not limited thereto. Main portions shown in the drawing will be described, but descriptions of other portions will be omitted.

FIG. 2 is a schematic configuration diagram showing an exemplary embodiment of an image forming apparatus including a developing device to which the electrostatic charge image developer according to the exemplary embodiment is applied.

In the drawing, the image forming apparatus according to the exemplary embodiment has a photoreceptor drum 20 as an image holding member that rotates in a predetermined direction, and a charging device 21 that charges the photoreceptor drum 20, an exposing device 22, for example, as a electrostatic charge image forming device that forms an electrostatic charge image z on the photoreceptor drum 20, a developing device 30 that visualizes the electrostatic charge image Z formed on the photoreceptor drum 20, a transfer device 24 that transfers the visualized toner image on the photoreceptor drum 20 onto a recording sheet 28 as a recording medium, and a cleaning device 25 that cleans the toner remaining on the photoreceptor drum 20 are sequentially arranged around the photoreceptor drum 20.

In the exemplary embodiment, as shown in FIG. 2, the developing device 30 includes a developing housing 31 that accommodates a developer G containing a toner 40. In the developing housing 31, an opening 32 for developing facing the photoreceptor drum 20 is opened, and a developing roll (developing electrode) 33 as a toner holding member facing the opening 32 for developing is arranged. When a predetermined developing bias is applied to the developing roll 33, an electric field of developing is formed in an area (developing area) which is an area interposed between the photoreceptor drum 20 and the developing roll 33. In addition, a charge injecting roll (injecting electrode) 34 as a charge injecting member that faces the developing roll 33 is arranged in the developing housing 31. Particularly, in the exemplary embodiment, the charge injecting roll 34 also functions as a toner supplying roll that supplies the toner 40 to the developing roll 33.

Herein, the rotation direction of the charge injecting roll 34 may or may not be particularly determined. However, in consideration of the properties relating to the supply of the toner and the characteristics relating to the injection of charge, a constitution is preferable in which the charge injecting roll 34 rotates in the same direction and with a circumferential speed difference (for example, equal to or more than 1.5 times) in a portion facing the developing roll 33 such that the toner 40 is inserted into the area interposed between the charge injecting roll 34 and the developing roll 33, and injects charge while sliding.

Next, the operation of the image forming apparatus according to the exemplary embodiment will be described.

When an image forming process begins, first, the surface of the photoreceptor drum 20 is charged by the charging device 21, the exposing device 22 writes the electrostatic charge image Z on the charged photoreceptor drum 20, and the developing device 30 visualizes the electrostatic charge image Z as a toner image. Subsequently, the toner image on the photoreceptor drum 20 is transported to a transfer portion, and the transfer device 24 electrostatically transfers the toner image on the photoreceptor drum 20 to the recording sheet 28 as a recording medium. The residual toner on the photoreceptor drum 20 is cleaned by the cleaning device 25. Thereafter, the toner image on the recording sheet 28 is fixed by a fixing device 36 provided with a fixing member 36A (a fixing belt, a fixing roll, and the like) and a pressing member 36B and thus an image is obtained.

Process Cartridge and Toner Cartridge

A process cartridge according to the exemplary embodiment will be described.

The process cartridge according to the exemplary embodiment is a process cartridge including a developing unit which accommodates the electrostatic charge image developer according to the exemplary embodiment and develops an electrostatic charge image formed on a surface of an image holding member as a toner image with the electrostatic charge image developer, and is detachable from the image forming apparatus.

Without being limited to the configuration described above, the process cartridge according to the exemplary embodiment may have a configuration including a developing device, and, if necessary, at least one selected from other units such as an image holding member, a charging unit, an electrostatic charge image forming unit, and a transfer unit.

Hereinafter, an example of the process cartridge according to the exemplary embodiment will be shown. However, there is no limitation thereto. Main portions shown in the drawing will be described, but descriptions of other portions will be omitted.

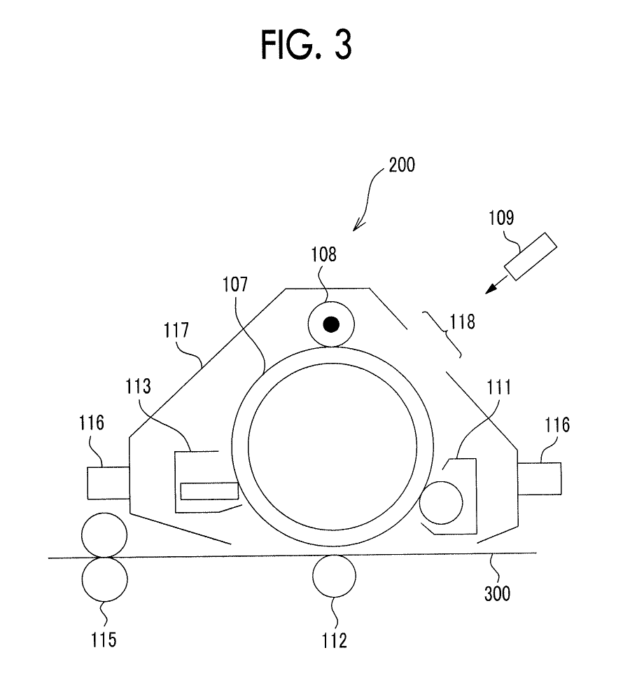

FIG. 3 is a schematic configuration diagram showing an example of a process cartridge according to an exemplary embodiment.

A process cartridge 200 shown in FIG. 3 is formed as a cartridge having a configuration in which a photoreceptor 107 (an example of the image holding member), a charging roll 108 (an example of the charging unit) provided around the photoreceptor 107, a developing device 111 (an example of the developing unit), and a photoreceptor cleaning device 113 (an example of the cleaning unit) are integrally combined and held by, for example, a housing 117 provided with a mounting rail 116 and an opening 118 for exposure.

In FIG. 3, the reference numeral 109 represents an exposure device (an example of the electrostatic charge image forming unit), the reference numeral 112 represents a transfer device (an example of the transfer unit), the reference numeral 115 represents a fixing device (an example of the fixing unit), and the reference numeral 300 represents a recording sheet (an example of the recording medium).

Next, a toner cartridge according to the exemplary embodiment will be described.

The toner cartridge according to the exemplary embodiment may be configured to accommodate the toner according to the exemplary embodiment and be detachable from an image forming apparatus. The toner cartridge according to the exemplary embodiment may accommodate at least toner and may accommodate, for example, a developer according to the configuration of the image forming apparatus.

The image forming apparatus shown in FIG. 2 has a configuration from which a toner cartridge (not shown) is freely detachable, and the developing device 30 is connected to the toner cartridge via a toner supply tube (not shown). In addition, when the toner accommodated in the toner cartridge runs low, the toner cartridge may be replaced.

### EXAMPLES

Hereinafter, the exemplary embodiment will be described in detail with reference to examples but the exemplary embodiment is not limited to these examples. In the following description, unless specified otherwise, “part (s)” and “%” are all based on weight.

Preparation of Unmodified Polyester Resin (1)

| | | |
|---|---|---|
| Terephthalic acid: | 1,243 | parts |
| Ethylene oxide adduct of bisphenol A: | 1,830 | parts |
| Propylene oxide adduct of bisphenol A: | 840 | parts |

The above components are mixed and heated at 180° C., and then 3 parts of dibutyltin oxide is added thereto. The mixture is heated at 220° C. to distill water, and thus an unmodified polyester resin is obtained. The glass transition temperature Tg of the obtained unmodified polyester resin is 60° C., the acid value is 3 mgKOH/g, and the hydroxyl value is 1 mgKOH/g.

Preparation of Polyester Prepolymer (1)

| | | |
|---|---|---|
| Terephthalic acid: | 1,243 | parts |
| Ethylene oxide adduct of bisphenol A: | 1,830 | parts |
| Propylene oxide adduct of bisphenol A: | 840 | parts |

The above components are mixed and heated at 180° C., and then 3 parts of dibutyltin oxide is added thereto. The mixture is heated at 220° C. to distill water, and thus a polyester is obtained. 350 parts of the obtained polyester, 50 parts of tolylene diisocyanate, and 450 parts of ethyl acetate are put into a vessel, and the mixture is heated to 130° C. for 3 hours. Thus, a polyester prepolymer (1) having isocyanate groups (hereinafter, referred to as “isocyanate-modified polyester prepolymer (1)”) is obtained.

Preparation of Ketimine Compound (1)

50 parts of methyl ethyl ketone and 150 parts of hexamethylenediamine are put into a vessel and stirred at 60° C. to obtain a ketimine compound (1).

Preparation of Brilliant Pigment Dispersion (1)

| | |
|---|---|
| Aluminum pigment (flake-shaped brilliant pigment, 2173EA, | 100 parts |
| manufactured by Showa Aluminum Powder K.K.): | |
| Ethyl acetate: | 500 parts |

The above-described components are mixed, the mixture is filtered, and 500 parts of ethyl acetate is further mixed. This operation is repeated 5 times and then the resultant mixture is dispersed using an emulsifying disperser Cavitron (CR1010, manufactured by Pacific Machinery & Engineering Co., Ltd.) for about 1 hour. Thus, a brilliant pigment dispersion (1) (solid concentration: 10%) in which a brilliant pigment (aluminum pigment) is dispersed is obtained.

Preparation of Organic Pigment Dispersion (1)

| | |
|---|---|
| Organic Pigment (C. I. Yellow 74 (Hansa Yellow 5GX01), | 100 parts |
| yellow pigment, manufactured by Clariant Catalysts (Japan) | |
| K.K.): | |
| Ethyl acetate: | 500 parts |

The above-described components are mixed, the mixture is filtered, and 500 parts of ethyl acetate is further mixed. This operation is repeated 5 times and then the resultant mixture is dispersed using an emulsifying disperser Cavitron (CR1010, manufactured by Pacific Machinery & Engineering Co., Ltd.) for about 1 hour. Thus, an organic pigment dispersion (1) (solid concentration: 10%) in which an organic pigment is dispersed is obtained.

Preparation of Release Agent Dispersion (1)

| | | |
|---|---|---|
| Paraffin wax (melting temperature: 89° C.): | 30 | parts |
| Ethyl acetate: | 270 | parts |

The above-described components are wet-pulverized by a microbead disperser (DCP mill) in a state of being cooled to 10° C. and thus a release agent dispersion (1) is obtained.

Preparation of Oil Phase Liquid (1)

| | | |
|---|---|---|
| Unmodified polyester resin (1): | 136 | parts |
| Brilliant pigment dispersion (1): | 500 | parts |
| Organic Pigment Dispersion (1): | 125 | parts |
| Ethyl acetate: | 56 | parts |

The above-described components are mixed under stirring and then 75 parts of the release agent dispersion (1) is added to the obtained mixture and stirred. Thus, an oil phase liquid (1) is obtained.

Preparation of Styrene Acryl Resin Particle Dispersion (1)

| | | |
|---|---|---|
| Styrene: | 370 | parts |
| n-Butyl acrylate: | 30 | parts |
| Acrylic acid: | 4 | parts |
| Dodecanthiol: | 24 | parts |
| Carbon tetrabromide: | 4 | parts |

A mixture obtained by mixing and dissolving above-described components is dispersed in an aqueous solution in which 6 parts of a nonionic surfactant (Nonipol 400, manufactured by Sanyo Chemical Industries, Ltd.) and 10 parts of an anionic surfactant (Neogen SC, manufactured by DKS Co. Ltd.) are dissolved in 560 parts of ion exchange water, and the dispersion is emulsified in a flask. Then, while mixing the components for 10 minutes, an aqueous solution in which 4 parts of ammonium persulphate is dissolved in 50 parts of ion exchange water is added thereto, and the flask is purged with nitrogen. Then, the content in the flask is heated in an oil bath, while stirring, until the temperature of the content reaches 70° C., and allowed to stand to perform emulsion polymerization for 5 hours. Thus, a styrene acryl resin particle dispersion (1) in which resin particles having an average particle size of 180 nm and a weight average molecular weight (Mw) of 15,500 (resin particle concentration: 40%) are dispersed is obtained. The glass transition temperature of the styrene acryl resin particles is 59° C.

Preparation of Water Phase Liquid (1)

| | | |
|---|---|---|
| Styrene acryl resin particle dispersion (1): | 60 | parts |
| 2% Aqueous Cerogen BS-H solution (manufactured | 200 | parts |
| by DKS Co. Ltd.): | | |
| Ion exchange water: | 200 | parts |

The above-described components are stirred and mixed to obtain a water phase liquid (1).

### Example 1

Preparation of Toner Particles (1)

| | | |
|---|---|---|
| Oil phase liquid (1): | 300 | parts |
| Isocyanate-modified polyester prepolymer (1): | 25 | parts |
| Ketimine compound (1): | 0.5 | parts |

The above-described components are put into a vessel and stirred for 2 minutes with a homogenizer (Ultra Turrax, manufactured by IKA) and thus an oil phase liquid (1P) is obtained. Then, 1,000 parts of the water phase liquid (1) is added into the vessel and the components are stirred for 20 minutes with the homogenizer. Next, the mixed solution is stirred for 48 hours at room temperature (25° C.) and normal pressure (1 atmosphere) with a propeller-type stirrer. Then, the isocyanate-modified polyester prepolymer (1) is allowed to react with the ketimine compound (1) to form a urea-modified polyester resin and to remove the organic solvent. Thus, a particulate material is formed. Next, the particulate material is washed with water, dried and classified to obtain toner particles (1). The volume average particle diameter of the toner particles is 12 μm.

Preparation of Brilliant Toner (1) 100 parts of the toner particles (1), 1.5 parts of hydrophobic silica (RY50, manufactured by Nippon Aerosil Co. Ltd.), and 1.0 part of hydrophobic titanium oxide (T805, manufactured by Nippon Aerosil Co. Ltd.) are mixed using a sample mill at 10,000 rpm for 30 seconds. Then, the resultant mixture is sieved with a vibration sieve having an opening of 45 μm to obtain a brilliant toner (1).

### Example 2

Toner particles (2) are obtained in the same manner as in the preparation of the toner particles (1) except that 25 parts of the isocyanate-modified polyester prepolymer (1), and 0.5 parts of the ketimine compound (1) in the preparation of the toner particles (1) are changed to 45 parts of the isocyanate-modified polyester prepolymer (1) and 0.9 parts of the ketimine compound (1).

A brilliant toner (2) is obtained in the same manner as in the preparation of the brilliant toner (1) except that the toner particles (2) are used.

### Example 3

Toner particles (3) are obtained in the same manner as in the preparation of the toner particles (1) except that 25 parts of the isocyanate-modified polyester prepolymer (1), and 0.5 parts of the ketimine compound (1) in the preparation of the toner particles (1) are changed to 15 parts of the isocyanate-modified polyester prepolymer (1) and 0.3 parts of the ketimine compound (1).

A brilliant toner (3) is obtained in the same manner as in the preparation of the brilliant toner (1) except that the toner particles (3) are used.

### Example 4

Toner particles (4) are obtained in the same manner as in the preparation of the toner particles (1) except that instead of using 25 parts of the isocyanate-modified polyester prepolymer (1), and 0.5 parts of the ketimine compound (1) in the preparation of the toner particles (1), 25 parts of an ion crosslinkable polyester resin formed by kneading, a mixture obtained by mixing 1,800 parts of the unmodified polyester resin (1) and 1,200 parts of an aqueous solution in which 1.8 parts of magnesium chloride is dissolved using a Henschel mixer (by Mitsui Mining Co., Ltd.), at 130° C. for 2 hours using two rolls, then rolling and cooling the mixture, and the pulverizing the resultant using a pulverizer is used.

A brilliant toner (4) is obtained in the same manner as in the preparation of the brilliant toner (1) except that the toner particles (4) are used.

### Example 5

Toner particles (5) are obtained in the same manner as in the preparation of the toner particles (1) except that 300 parts of the oil phase liquid (1) in the preparation of the toner particles (1) is changed to 400 parts of the oil phase liquid (1).

A brilliant toner (5) is obtained in the same manner as in the preparation of the brilliant toner (1) except that the toner particles (5) are used.

### Example 6

Toner particles (6) are obtained in the same manner as in the preparation of the toner particles (1) except that 300 parts of the oil phase liquid (1) in the preparation of the toner particles (1) is changed to 200 parts of the oil phase liquid (1).

A brilliant toner (6) is obtained in the same manner as in the preparation of the brilliant toner (1) except that the toner particles (6) are used.

### Comparative Example 1

Toner particles (C1) are obtained in the same manner as in the preparation of the toner particles (1) except that 25 parts of the isocyanate-modified polyester prepolymer (1), and 0.5 parts of the ketimine compound (1) in the preparation of the toner particles (1) are changed to 5 parts of the isocyanate-modified polyester prepolymer (1) and 0.1 parts of the ketimine compound (1).

A brilliant toner (C1) is obtained in the same manner as in the preparation of the brilliant toner (1) except that the toner particles (C1) are used.

### Comparative Example 2

Toner particles (C2) are obtained in the same manner as in the preparation of the toner particles (1) except that 25 parts of the isocyanate-modified polyester prepolymer (1), and 0.5 parts of the ketimine compound (1) in the preparation of the toner particles (1) are changed to 50 parts of the isocyanate-modified polyester prepolymer (1) and 1.0 parts of the ketimine compound (1).

A brilliant toner (C2) is obtained in the same manner as in the preparation of the brilliant toner (1) except that the toner particles (C2) are used.

Measurement and Evaluation

Measurement of Toluene Insoluble Portion

The toluene insoluble portion of each brilliant toner obtained in the respective examples (toluene insoluble portion other than the brilliant pigment and the external additive) are measured according to the above-described method. The results are shown in Table 1.

Preparation of Developer

36 parts of each of the brilliant toners obtained in the respective examples and 414 parts of a carrier are put into a 2 L V blender and stirred for 20 minutes, and the resultant is then sieved with a sieve having an opening of 212 μm to prepare each developer. As the carrier, a carrier obtained in the following manner is used.

Preparation of Carrier

| | | |
|---|---|---|
| Ferrite particles (volume average particle | 100 | parts |
| diameter 35 μm): | | |
| Toluene: | 14 | parts |
| Methyl methacrylate-perfluorooctyl ethyl acrylate | 1.6 | parts |
| copolymer (critical surface tension: 24 dyn/cm): | | |
| Carbon black (trade name: VXC-72, manufactured by | 0.12 | parts |
| Cabot Corporation, volume resistivity: 100 Ωcm or less): | | |
| Cross-linked melamine resin particles (average | 0.3 | parts |
| particle diameter: 0.3 μm, insoluble in toluene): | | |

First, the carbon black is diluted with the toluene and added to the methyl methacrylate-perfluorooctyl ethyl acrylate copolymer, followed by dispersion with a sand mill. Next, in the resultant, the respective above components other than the ferrite particles are dispersed with a stirrer for 10 minutes. Thus, a coating layer forming solution is prepared. Next, the coating layer forming solution and the ferrite particles are put into a vacuum degassing kneader, followed by stirring at a temperature of 60° C. for 30minutes. Then, the pressure is reduced to remove toluene, there by forming a resin coating layer. Thus, a carrier is obtained.

Evaluation

A developer unit of a modified machine of “color 800 press” manufactured by Fuji Xerox Co., Ltd. is filled with the obtained developer.

Using the modified machine, a belt-shaped solid image is printed on 10,000 sheets of OK Topcoat paper (paper weight: 127, manufactured by Oji Paper Co., Ltd.) with an amount of brilliant toner applied of 4.5 g/m².

(Brilliance: Measurement of Ratio (X/Y))

The 10,000th printed solid image is irradiated with incident light at an incident angle of −45° with respect to the solid image using a spectro-goniophotometer GC 5000L manufactured by Nippon Denshoku Industries Co., Ltd. as a goniophotometer, and a reflectance X at a light receiving angle of +30° and a reflectance Y at a light receiving angle of −30° are measured. In addition, the reflectance X and the reflectance Y are respectively obtained by performing measurement with light in a wavelength range of 400 nm to 700 nm in increments of 20 nm and calculating the average value of reflectances of the respective wavelengths. The ratio (X/Y) is calculated from the measurement results. The results are shown in Table 1.

As the ratio (X/Y) becomes higher, the brilliance becomes higher. As the ratio (X/Y) becomes lower, the dull effect becomes stronger and the brilliance is less likely to be exhibited.

Evaluation of Change in Color Tone

A change in color tone of the 10, 000th printed solid image is evaluated based on the following evaluation criteria. The results are shown in Table 1.
A: A change in color tone of the surface of the solid image is not observed.
B: A slight change in color tone of the surface of the solid image is observed.
C: A change in color tone of the surface of the solid image is observed but is in an acceptable range.
D: A remarkable change in color tone of the surface of the solid image is observed and is out of an acceptable range.

TABLE 1

| | | | Number of pigment | Toluene | | | |
|---|---|---|---|---|---|---|---|
| | | | particles in a | insoluble | Presence or absence | | Change |
| | | Ratio | range of ±30° | portion | of urea-modified | Ratio | in color |
| | No. | (C/D) | (% by number) | (% by weight) | polyurethane resin | (X/Y) | tone |
| Example 1 | 1 | 0.41 | 78 | 20.3 | Presence | 8.8 | A |
| Example 2 | 2 | 0.38 | 82 | 39.7 | Presence | 6.5 | C |
| Example 3 | 3 | 0.44 | 75 | 8.5 | Presence | 10.2 | C |
| Example 4 | 4 | 0.42 | 78 | 15.6 | Absence | 9.4 | C |
| Example 5 | 5 | 0.18 | 93 | 20.5 | Presence | 9.8 | B |
| Example 6 | 6 | 0.63 | 68 | 19.8 | Presence | 6.8 | C |
| Comparative | C1 | 0.44 | 76 | 7.6 | Presence | 12.3 | D |
| Example 1 | | | | | | | |
| Comparative | C2 | 0.38 | 80 | 41 | Presence | 3.8 | — |
| Example 2 | | | | | | | |

In Table 1, “Number of pigment particles in a range of ±30° refers to a proportion of the brilliant pigment particles arranged so that an angle formed by a long axis direction of the toner particles in the cross section and a long axis direction of the brilliant pigment particles is in a range of −30° to +30° in the case of observing the cross section of the toner particles in the thickness direction.

In addition, since brilliance is not obtained in Comparative Example 2, a change in color tone is not evaluated.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A brilliant toner comprising:
toner particles containing a brilliant pigment, an organic pigment, a binder resin and a release agent; and
an external additive,
wherein a toluene insoluble portion other than the brilliant pigment and the external additive is from 8% by weight to 40% by weight.

2. The brilliant toner according to claim 1,
wherein the toner includes aluminum as the brilliant pigment.

3. The brilliant toner according to claim 1, wherein the brilliant pigment has an aspect ratio of 5 to 200.

4. The brilliant toner according to claim 1,
wherein a glass transition temperature (Tg) of the binder resin is from 50° C. to 80° C.

5. The brilliant toner according to claim 1,
wherein the binder resin includes polyester.

6. The brilliant toner according to claim 5,
wherein a weight average molecular weight (Mw) of the polyester resin is from 7,000 to 500,000.

7. The brilliant toner according to claim 1,
wherein the toner includes a urea-modified polyester resin as the binder resin.

8. The brilliant toner according to claim 1,
wherein a ratio (C/D) between an average maximum thickness C and an average equivalent circle diameter D of the toner particles is from 0.001 to 0.700.

9. The brilliant toner according to claim 1,
wherein a proportion of the brilliant pigment particles arranged so that an angle formed by a long axis direction of the toner particle in the cross section and a long axis direction of the brilliant pigment particle is in a range of −30° to +30° is 60% or more of the total number of the brilliant pigment particles.

10. The brilliant toner according to claim 1,
wherein a content of the brilliant pigment is from 15 parts by weight to 25 parts by weight with respect to 100 parts by weight of the toner particles and a content of the organic pigment is from 3 parts by weight to 15 parts by weight.

11. An electrostatic charge image developer comprising:
the brilliant toner according to claim 1.

12. A toner cartridge that accommodates the brilliant toner according to claim 1 and is detachable from an image forming apparatus.
